(19) United States
(12) Patent Application Publication
(10) Pub. No.: US 2006/0043628 A1
(43) Pub. Date: Mar. 2, 2006

(54) CMC process using a water-based prepreg slurry

(75) Inventor: Roger Lee Ken Matsumoto, Newark, DE (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/915,327

(22) Filed: Aug. 11, 2004

(51) Int. Cl. B29C 70/34

(52) U.S. Cl. 264/137

(57) ABSTRACT

A process for forming a ceramic matrix composite component, for example, a turbine component, includes (a) applying a fiber coating to a fiber tow by chemical vapor deposition; (b) pulling the fiber tow through an aqueous slurry composed of high and low temperature binders, silicon carbide powder, carbon black and water to thereby form a prepreg tape; and (c) winding the prepreg tape on a drum.

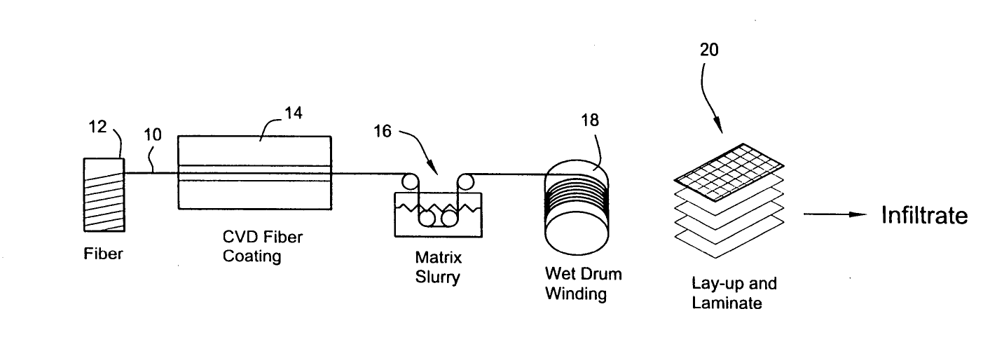

### BACKGROUND OF THE INVENTION

This invention relates to the manufacture of ceramic matrix components and particularly to a formulation that uses water as the liquid carrier in a prepreg slurry containing particulate silicon carbide, carbon black and high and low temperature binders.

The development of high temperature materials in the past five decades has been paced by their need in demanding structural applications, particularly in gas turbines. The materials being used today in hot sections of gas turbines are nickel and cobalt-based super alloys. In many cases, they are currently being used at temperatures of ˜1100° C.

Ceramics are refractory materials, offering stability at temperatures much higher than 1100° C., and are therefore attractive for gas turbine applications. Monolithic structural ceramics, such as SiC and Si3N4, have been available for over four decades, but have not found applications in gas turbines because of their lack of damage tolerance and catastrophic failure mode. However, ceramic matrix composites (CMCs), particularly those reinforced with continuous fibers, offer significant damage tolerance and more graceful failure modes. Melt Infiltrated (MI) SiC/SiC composites are particularly attractive for gas turbine applications because of their high thermal conductivity, excellent thermal shock resistance, creep resistance, and oxidation resistance compared to other CMCs.

A variety of processing schemes have been developed for the fabrication of MI-CMCs. One process is known as the “prepreg process” and the other is known as the “slurry cast” process. This invention relates primarily to the prepreg process.

The first step in the typical prepreg process is the application of a fiber coating via chemical vapor deposition (CVD). CMCs have typically in the past used carbon as the fiber coating, but have since incorporated boron nitride or silicon-doped boron nitride for increased oxidation resistance.

Following fiber coating, the fiber tow is pulled through a slurry containing the preform matrix constituents (SiC and carbon particulate, binders and solvents), and then wound on a drum to form a unidirectional pre-impregnated, i.e., “prepreg,” tape. The tape is then dried, removed from the drum, cut to shape, laid-up to give the desired fiber architecture, and laminated to form a green composite preform.

The final densification step is a silicon-melt infiltration step. The composite preform, containing the coated SiC fibers, SiC and/or carbon particulates, and organic binders is heated above about 1420° C. while in contact with a source of molten silicon metal.

A current slurry formulation for prepregging the SiC preform uses non-aqueous solvents that pose hazards in industrial uses. The non-aqueous solvents are typically combined with high temperature and low temperature binders that are soluble in the non-aqueous solvent but not in water.

### BRIEF DESCRIPTION OF THE INVENTION

This invention relates to a formulation that uses water as the liquid carrier for the prepreg slurry. In the exemplary embodiment, the slurry contains water, a particulate silicon carbide, carbon black, a high temperature binder and a low temperature binder. The invention thus eliminates the prior non-aqueous system in favor of a less hazardous aqueous system that nevertheless acts in substantially the same manner.

Accordingly, in one aspect, the invention relates to a process for forming a ceramic matrix composite component comprising (a) applying a fiber coating to a fiber tow by chemical vapor deposition; (b) pulling the fiber tow through an aqueous slurry composed of high and low temperature binders, silicon carbide powder, carbon black and water to thereby form a prepreg tape; and (c) winding the prepreg tape on a drum.

In another aspect, the invention relates to a process for forming a ceramic matrix composite component comprising (a) applying a fiber coating to a fiber tow; (b) pulling the fiber tow through an aqueous slurry composed of high and low temperature binders, silicon carbide powder, carbon black and water to thereby form a prepreg tape; (c) winding the prepreg tape on a drum; (d) cutting, laying up and laminating the prepreg tape to form a composite preform; (e) melt infiltrating the preform with molten silicon; and (f) machining the preform to form the ceramic matrix composite component; wherein the low temperature binder comprises an acrylic emulsion; and wherein the high temperature binder comprises a single stage phenolic resin.

In still another aspect, the invention relates to a process for forming a ceramic matrix composite component comprising (a) applying a fiber coating to a fiber tow by chemical vapor deposition; (b) pulling the fiber tow through an aqueous slurry composed of high and low temperature binders, silicon carbide powder, carbon black and water to thereby form a prepreg tape; (c) winding the prepreg tape on a drum; (d) cutting, laying up and laminating the prepreg tape to form a composite preform; (e) melt infiltrating the preform with molten silicon; and (f) machining the preform to the shape of the gas turbine component.

The invention will now be described in detail in connection with the drawing figure identified below.

### BRIEF DESCRIPTION OF THE DRAWINGS

The sole FIGURE is a schematic diagram of a conventional Prepreg Melt Infiltration process used in the fabrication of MI-CMC's.

### DETAILED DESCRIPTION OF THE INVENTION

With reference to the FIGURE, a conventional prepreg process used for the fabrication of MI-CMC's begins with an SiC multi-filament fiber tow, typically Hi-Nicalon™ or Sylramic™ fiber. Specifically, the fiber tow 10 is unwound from a wheel or drum 12 and is passed through a housing or chamber 14 where the fibers are coated by means of a conventional chemical vapor deposition (CVD) process. This coating of the fibers, typically with a ceramic material, serves to protect the fibers during composite processing and provides a low strength fiber-matrix interface, thereby enabling the fiber-matrix debonding and fiber pull-out toughening mechanisms. CMC's have typically used carbon as the fiber coating, but now also incorporate boron nitride or silicon-doped boron nitride for increased oxidation resistance.

Following fiber coating by CVD, the fiber tow is pulled through a matrix slurry vessel 16 containing a non-aqueous preform matrix slurry containing SiC, carbon particulate, binders and solvents. The tow is then wound on a drum 18 to form a unidirectional pre-impregnated tape. The tape is then dried, removed from the drum, cut to shape, laid-up to give the desired fiber architecture and laminated to form a green composite preform 20. If desired, machining of the preform can be done at this stage, helping to reduce the amount of final machining of the part after densification.

The final densification step is generally referred to as silicon melt infiltration. The composite preform 20, containing the coated SiC fibers, SiC and/or carbon particulates is heated above about 420° C. while in contact with a source of molten silicon metal. Molten silicon readily wets the SiC and/or carbon, and is therefore easily pulled into the remaining porosity of the preform by a capillary process. No external driving force is needed for the infiltration, and there is no dimensional change to the composite preform.

In one exemplary embodiment of this invention, a water-based prepreg matrix slurry formulation for introduction into the vessel 16 includes, in addition to water, Rhoplex® B-60A (an acrylic emulsion) as the low temperature binder, and Rutgers Plenco single stage phenolic Resin No. 12114 as the high temperature binder. The silicon carbide powder (HSC-059) is the same as currently used in the non-aqueous system, as is the carbon black. Due to the nature of water-based systems, known dispersants may be added along with any suitable pH control component.

To verify the efficacy of the prepreg slurry as described above, the following procedure was followed: 164 g of deionized water, 3 g of TEGO Dispers 750, and 140 g HSC-059 SiC were placed in a 1000 ml jar along with alumina milling balls. The jar was allowed to rotate, or roll, overnight. After approximately twelve hours, there were no clumps of SiC visible, and the following were then added to the jar in the given order, with a shake of the jar in between each addition: 3 g TEGO, 60 g carbon black, 2 g ammonium hydroxide, 68.3 g Rhoplex® B-60A emulsion and 56 g phenolic resin. This formulation was allowed to roll in the jar for 1 hour. A small quantity was placed in a beaker and de-aired under vacuum. A casting was made on a plastic sheet. After drying, this casting was laminated. It was found that this slurry performed in much the same manner as conventional non-aqueous slurries. Actual component parts have now also been made in accordance with the above process, further confirming the viability of using an aqueous-based prepreg slurry.

An alternative method is to dry the tow or tape by running the filled tow or tape through a dryer to fully cure the acrylic resin binder. Later, this tow or tape can be passed through a safe solvent such as acetone or alcohol and used to make parts by processes such as tape placement. This technology is used extensively in the organic composites industry.

The process described herein may be utilized to produce many different gas turbine components including combustor liners, shrouds and other large three-dimensional parts requiring high temperature resistance.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for forming a ceramic matrix composite component comprising:
(a) applying a fiber coating to a fiber tow by chemical vapor deposition;
(b) pulling the fiber tow through an aqueous slurry composed of high and low temperature binders, silicon carbide powder, carbon black and water to thereby form a prepreg tape; and
(c) winding the prepreg tape on a drum.

2. The process of claim 1 and further comprising:
(d) cutting, laying up and laminating the prepreg tape to form a composite preform; and
(e) melt infiltrating the preform with molten silicon.

3. The process of claim 1 wherein the low temperature bender comprises an acrylic emulsion.

4. The process of claim 1 wherein the high temperature binder comprises a single stage phenolic resin.

5. The process of claim 2 wherein the high temperature binder comprises a single stage phenolic resin.

6. The process of claim 1 wherein, after step (c), and prior to step (d), the tape is dried and removed from the drum.

7. The process of claim 5 wherein, after step (c), and prior to step (d), the tape is dried and removed from the drum.

8. The process of claim 1 wherein the composite component comprises a combustor component in a gas turbine.

9. A process for forming a ceramic matrix composite component comprising:
(a) applying a fiber coating to a fiber tow;
(b) pulling the fiber tow through an aqueous slurry composed of high and low temperature binders, silicon carbide powder, carbon black and water to thereby form a prepreg tape;
(c) winding the prepreg tape on a drum;
(d) cutting, laying up and laminating the prepreg tape to form a composite preform;
(e) melt infiltrating the preform with molten silicon; and
(f) machining the preform to form the ceramic matrix composite component; wherein the low temperature binder comprises an acrylic emulsion; and wherein the high temperature binder comprises a single stage phenolic resin.

10. The process of claim 9 wherein the composite component comprises a combustor component in a gas turbine.

11. A process for forming a ceramic matrix composite gas turbine component comprising:
(a) applying a fiber coating to a fiber tow by chemical vapor deposition;
(b) pulling the fiber tow through an aqueous slurry composed of high and low temperature binders, silicon carbide powder, carbon black and water to thereby form a prepreg tape;
(c) winding the prepreg tape on a drum;
(d) cutting, laying up and laminating the prepreg tape to form a composite preform;
(e) melt infiltrating the preform with molten silicon; and
(f) machining the preform to the shape of the gas turbine component.

12. The process of claim 11 wherein the low temperature binder comprises an acrylic emulsion.

13. The process of claim 11 wherein the high temperature binder comprises a single stage phenolic resin.

14. The process of claim 11 wherein, after step (c), and prior to step (d), the tape is dried and removed from the drum.

15. A turbine component made by the process of claim 9.
